(19) United States
(12) Patent Application Publication
(10) Pub. No.: US 2011/0107096 A1
(43) Pub. Date: May 5, 2011

(54) Method, apparatus and system for managing DRM content

(75) Inventor: Seong Min Je, Bucheon-si (KR)

(73) Assignee: SAMSUNG ELECTRONIS CO., LTD., Suwon-si (KR)

(21) Appl. No.: 12/925,437

(22) Filed: Oct. 21, 2010

(30) Foreign Application Priority Data
Oct. 30, 2009 (KR) 10-2009-0103993

(51) Int. Cl. H04L 9/32; G06F 21/24

(52) U.S. Cl. 713/168; 713/150

(57) ABSTRACT

A method and an apparatus manages DRM (digital rights management) content with a forward lock so that the DRM content can also be used in other devices. The method comprises receiving DRM content with a forward lock from a content provider server. The DRM content is encoded by using an encoding key based on a user input such that the encoded DRM content cannot be decoded by another device without the encoding key. The encoded DRM content is transmitted to another mobile device after establishing a communication channel with the other mobile device.

### CROSS-REFERENCE TO RELATED APPLICATION(S) AND CLAIM OF PRIORITY

The present application claims the benefit under 35 U.S.C. 119(a) to a Korean patent application filed in the Korean Intellectual Property Office on Oct. 30, 2009 and assigned Serial No. 10-2009-0103993, the entire disclosure of which is hereby incorporated by reference.

### TECHNICAL FIELD OF THE INVENTION

The present invention relates generally to digital rights management (DRM) technology and, more particularly, to a method, apparatus and system for managing DRM content in which a forward lock is created.

### BACKGROUND OF THE INVENTION

With the advent of new techniques and functions arousing customers' interest, the market of mobile devices is making a rapid and strong growth. Moreover, dramatic advances in mobile communication technology are investing traditional mobile devices with a variety of applications that meet customers' demands.

Meanwhile, to protect paid contents being used in mobile devices from illegal copy or unauthorized redistribution, digital rights management (DRM) technology has been recently proposed. To impose limitations on the usage of contents and, thereby, to effectively ensure the right of copyright holders, DRM applies encryption techniques to a variety of digital contents such as text, music, image, video, film, software, and games. Implementations of DRM technology include a forward lock, a combined delivery of content and right object, and a separate delivery of content and right object. A forward lock prevents a user of a mobile device from forwarding purchased content to other devices.

In addition, a user may wish to use DRM content downloaded through a mobile device in some other device or content player. For instance, a user may wish to use DRM content in a certain content player (such as MP3 player, PMP (portable multimedia player)) that is inaccessible to a content provider server. Because the usage of content is limited to an authorized user, there is little concern for illegal copy or unauthorized redistribution. However, DRM content with a forward lock may not meet user demands because the delivery to other devices is not allowed.

### SUMMARY OF THE INVENTION

To address the above-discussed deficiencies of the prior art, it is a primary object to provide a method for managing DRM content with a forward lock such that the DRM content can also be used in other devices.

Another aspect of the present invention is to provide an apparatus and system that adopts the above method for managing DRM content.

According to an aspect of the present invention, a method for managing DRM (digital rights management) content is provided. The method includes receiving DRM content with a forward lock from a content provider server. At the first mobile device, the DRM content is encoded by using an encoding key based on a user input such that the encoded DRM content cannot be decoded by another device without the encoding key. The encoded DRM content is transmitted from the first mobile device to another mobile device after establishing a communication channel with another mobile device.

According to another aspect of the present invention, an apparatus for managing DRM (digital rights management) content is provided. The apparatus includes a short distance communication unit configured to receive an encoded DRM content with a forward lock from a transmitting device. The apparatus also includes a control unit configured to prompt a user to enter a key for decoding the encoded DRM content, determine whether the key entered by the user is identical to the encoding key of the received encoded DRM content, decode the DRM content when the key entered by the user is identical to the encoding key, and play the decoded DRM content.

According to yet another aspect of the present invention, an apparatus for managing DRM (digital rights management) content is provided. The apparatus includes a first communication unit configured to receive DRM content with a forward lock from a content provider server. A display unit is configured to display a key input window for creating an encoding key for the DRM content. An encoder is configured to create the encoding key by using a key entered into the key input window, and to encode the DRM content by using the encoding key. A second communication unit is configured to establish a communication channel with an external device, and to transmit the encoded DRM content to the external device.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a DRM content managing system in accordance with an embodiment of the present invention;

FIG. 2 illustrates a configuration of the first mobile device in a DRM content managing system in accordance with an embodiment of the present invention;

FIG. 3 illustrates a configuration of the second mobile device in a DRM content managing system in accordance with an embodiment of the present invention;

FIG. 4 illustrates a DRM content managing process in accordance with an embodiment of the present invention;

FIG. 5 illustrates a process for encoding DRM content by the first mobile device in accordance with an embodiment of the present invention; and

FIG. 6 illustrates a process for decoding DRM content by the second mobile device in accordance with an embodiment of the present invention.

### DETAILED DESCRIPTION OF THE INVENTION

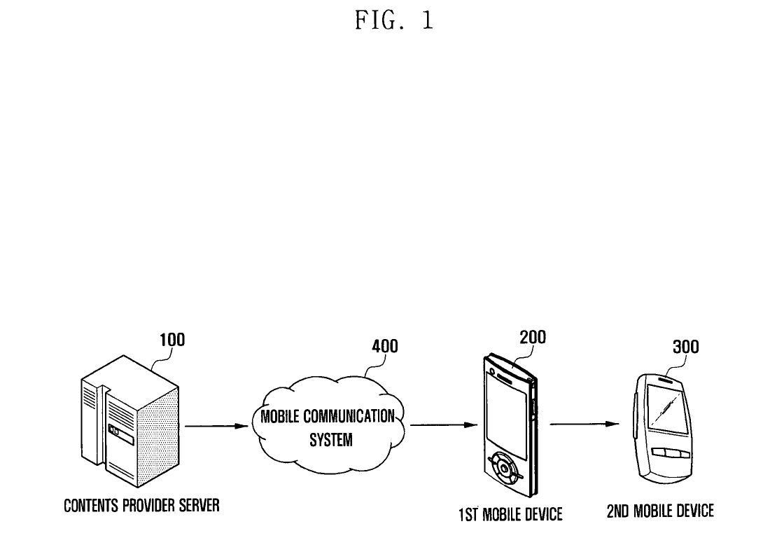

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication device capable of playing content. This invention may, however, be embodied in many different forms and should not be construed as limited to the embodiments set forth herein. Rather, the disclosed embodiments are provided such that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent embodiments of the invention, the drawings are not necessarily to scale and certain features may be exaggerated or omitted in order to better illustrate and explain the present invention.

Although the following embodiment adopts a mobile device for description, this is not to be considered as a limitation of the present invention. Alternatively, this invention may also be applied to any other devices capable of playing digital content.

FIG. 1 illustrates a digital rights management (DRM) content managing system in accordance with an embodiment of the present invention. Referring to FIG. 1, the DRM content managing system includes a content provider server 100, a first mobile device 200, a second mobile device 300, and a mobile communication system 400.

The content provider server 100 establishes a communication channel with the first mobile device 200 through the mobile communication system 400 and transmits DRM content to the first mobile device 200. Particularly, the content provider server 100 creates a forward lock in DRM content in order to prevent the DRM content from being copied or delivered to other devices and sends the DRM content with a forward lock to the first mobile device 200.

The first mobile device 200 receives the DRM content with a forward lock from the content provider server 100. The first mobile device 200 creates an encoding key by using a key input from a user, encodes the DRM content through the encoding key, and sends the encoded DRM content to the second mobile device 300.

The first mobile device 200 can play such DRM contents, access the content provider server 100 through the mobile communication system 400, and receive the DRM content downloaded. The first mobile device 200 may include all kinds of mobile communication terminals, digital broadcasting terminals, personal digital assistants (PDAs), smart phones, and such. The mobile communication terminal may include IMT-2000 (international mobile telecommunication 2000) devices, WCDMA (wideband code division multiple access) devices, GSM/GPRS (global system for mobile communication/general packet radio service) devices, UMTS (universal mobile telecommunication service) devices, and such. The first mobile device 200 not only has a specific communication module for accessing the content provider server 100, but also has a separate communication module for establishing a communication channel with the second mobile device 300. The communication module for connecting with the second mobile device 300 may include short distance communication modules (such as Bluetooth modules, Zigbee modules, UWB (ultra wideband) modules, and infrared communication modules), UART (universal asynchronous receiver/transmitter) communication modules, USB (universal serial bus) communication modules, and so forth.

The second mobile device 300 receives the encoded DRM content from the first mobile device 200 and also determines whether a user input key is identical to the encoding key used to encode the DRM content. If identical, the second mobile device 300 decodes the encoded DRM content.

The second mobile device 300 can play DRM content and may or may not have a function to access the content provider server 100. Namely, the second mobile device 300 may be any content player, such as MP3 player or PMP (portable multimedia player), which is inaccessible to the content provider server 100. However, the second mobile device 300 should have a separate communication module that allows communication with the first mobile device 200. Such communication modules may include short distance communication modules (such as Bluetooth modules, Zigbee modules, UWB modules, and infrared communication modules), UART communication modules, USB communication modules, and the like.

The mobile communication system 400 provides a network that allows the first mobile device 200 to access the content provider server 100. The mobile communication system 400 may include a base station for establishing a wireless communication channel with the first mobile device 200, a base station controller for controlling the base station, a mobile switching center, and a WAP gateway for providing access to the content provider server 100. The mobile communication system 400 mediates transmission of DRM contents between the content provider server 100 and the first mobile device 200.

Now, the configuration of the first and second mobile devices 200 and 300 will be described in detail.

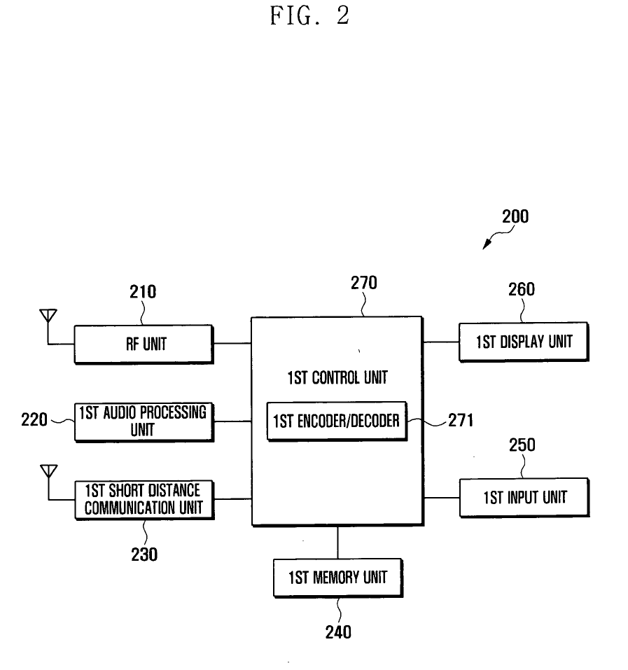

FIG. 2 illustrates the first mobile device in a DRM content managing system in accordance with an embodiment of the present invention. Referring to FIG. 2, the first mobile device 200 includes a radio frequency (RF) unit 210, a first audio processing unit 220, a first short distance communication unit 230, a first memory unit 240, a first input unit 250, a first display unit 260, and a first control unit 270.

The RF unit 210 performs a function to transmit and receive data for a wireless communication of the first mobile device 200. The RF unit 210 may include an RF transmitter that upwardly converts the frequency of transmitted signals and amplifies the transmitted signals, and an RF receiver that amplifies received signals with low-noise and downwardly converts the frequency of the received signals. Additionally, the RF unit 210 may receive data through a wireless channel and output it to the first control unit 270, and also may receive data from the first control unit 270 and transmit it through a wireless channel. Particularly, the RF unit 210 accesses the content provider server 100 through the mobile communication system 400 and receives the DRM content with a forward lock from the content provider server 100.

The first audio processing unit 220 may be formed of codec, which has a data codec for processing packet data and an audio codec for processing audio signals. The first audio processing unit 220 converts digital audio signals into analog audio signals through the audio codec and then outputs them through the speaker (SPK). Additionally, the first audio processing unit 220 converts analog audio signals from the microphone (MIC) into digital audio signals through the audio codec. Particularly, the first audio processing unit 220 performs a function to output audio data contained in the DRM content.

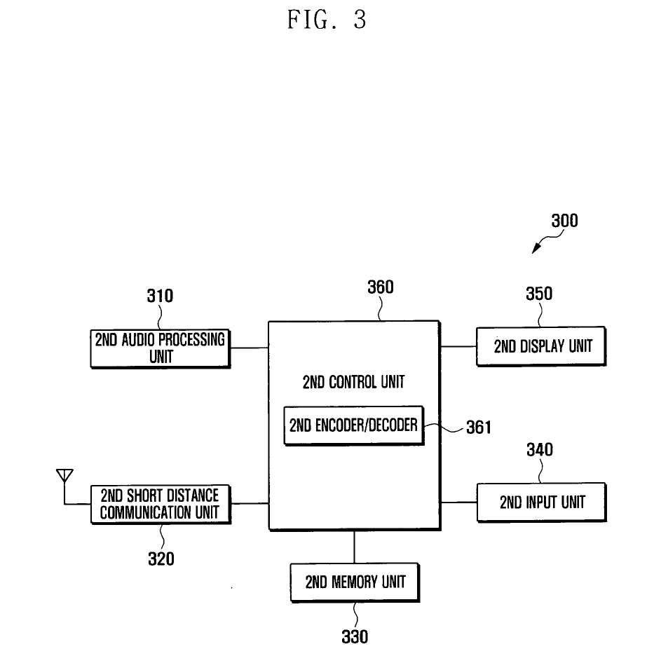

The first short distance communication unit 230 may be formed of a Bluetooth module, a Zigbee module, a UWB module, an infrared communication module, and such. The first short distance communication unit 230 performs a function to establish a communication channel with other external devices in order to transmit and receive data. For example, the first short distance communication unit 230 establishes a communication channel with a second short distance communication unit (320 in FIG. 3) of the second mobile device 300 and then sends the encoded DRM content to the second short distance communication unit 320.

The first memory unit 240 performs a function to store various programs and data required for operations of the mobile device, and thus includes a program region and a data region. The first memory unit 240 may be formed of a volatile or nonvolatile memory device or a combination thereof. For instance, a volatile memory device may use semiconductor memory devices such as RAM, DRAM or SRAM, and a nonvolatile memory device may use ROM, flash memory or a hard disk. The first memory unit 240 stores in the data region the DRM content received from the content provider server 100 and also stores in the program region a particular application for playing the DRM content. Additionally, the first memory unit 240 stores in the program region any application for encoding and decoding the DRM content received from the content provider server 100. Preferably, this encoding/decoding application is the same as that stored in a second memory unit (330 in FIG. 3) of the second mobile device 300.

The first input unit 250 creates a key input signal for controlling the mobile device in response to user interaction and sends the key input signal to the first control unit 270. The first input unit 250 may be formed of a keypad that adopts a ‘3*4 ’ or ‘QWERTY’key arrangement and has a plurality of alphanumeric keys, navigation keys and function keys. Alternatively or additionally, the first input unit 250 may be formed of a touch-sensitive surface such as a touch pad or a touch screen. Furthermore, various sensors such as an image sensor and an acceleration sensor may be used for the first input unit 250.

The first display unit 260 may be formed of LCD (liquid crystal display) or any other equivalent, and visually offers various menus, input data, function setting information, and any other various information to a user. For instance, the first display unit 260 performs a function to display a booting screen, an idle screen, a call screen, and any other application execution screens. Particularly, the first display unit 260 displays a key input interface for creating an encoding key for the DRM content.

The first control unit 270 performs the overall control operations related to the first mobile device 200. In particular, the first control unit 270 has a first encoder/decoder 271. Specifically, the first control unit 270 controls the RF unit 210 to receive the DRM content with a forward lock from the content provider server 100. Additionally, the first control unit 270 ascertains that a forward lock has been created in the received DRM content and controls the first display unit 260 to display a key input interface for creating an encoding key. When the first input unit 250 creates an input signal in response to a user's key input, the first control unit 270 receives the input signal from the first input unit 250 and recognizes the user's key input. The first encoder/decoder 271 designates a recognized key as an encoding key and encodes the DRM content by using the encoding key. The first control unit 270 also stores the encoded DRM content in the first memory unit 240.

Furthermore, the first control unit 270 controls the first short distance communication unit 230 to establish a communication channel with the second short distance communication unit 320 of the second mobile device 300. When the first input unit 250 creates an input signal in response to user's instructions to transmit the encoded DRM content, the first control unit 270 receives an input signal from the first input unit 250 and controls the first short distance communication unit 230 to send the encoded DRM content to the second short distance communication unit 320.

In an embodiment, the first mobile device 100 may further include a first wired communication unit (not shown). The first wired communication unit may be formed of a specific connector that is coupled to the second mobile device 300 through a wired cable. The first control unit 270 may also send the encoded DRM content to the second mobile device 300 through the first wired communication unit.

FIG. 3 illustrates the second mobile device in a DRM content managing system in accordance with an embodiment of the present invention. Referring to FIG. 3, the second mobile device 300 includes a second audio processing unit 310, a second short distance communication unit 320, a second memory unit 330, a second input unit 340, a second display unit 350, and a second control unit 360.

The second audio processing unit 310 is analogous to the first audio processing unit 220 of the first mobile device 200. Particularly, the second audio processing unit 310 performs a function to output audio data contained in the DRM content received from the first mobile device 200.

Like the first short distance communication unit 230 of the first mobile device 200, the second short distance communication unit 320 may be formed of a Bluetooth module, a Zigbee module, a UWB module, an infrared communication module, and such, and performs a function to establish communication with other external devices in order to transmit and receive data. Particularly, the second short distance communication unit 320 establishes a communication channel with the first short distance communication unit 230 of the first mobile device 200 and receives the encoded DRM content from the first short distance communication unit 230.

The second memory unit 330 performs a function to store various programs and data required for operations of the mobile device and, thus, includes a program region and a data region. Particularly, the second memory unit 330 stores in the data region the DRM content received from the first mobile device 200 and also stores in the program region a particular application for playing the DRM content. Additionally, the second memory unit 330 stores in the program region any application for encoding and decoding the DRM content. In some embodiments, this encoding/decoding application is the same as that stored in the first memory unit 240 of the first mobile device 200.

The second input unit 340 creates a key input signal for controlling the mobile device in response to user input and sends the key input signal to the second control unit 360. The second input unit 340 is analogous to the first input unit 250 of the first mobile device 200.

The second display unit 350 may be formed of LCD or any other equivalent, and visually offers various menus, input data, function setting information, and any other various information to a user. For example, the second display unit 350 displays a key input interface for entering a key for decoding the encoded DRM content.

The second control unit 360 performs an overall control function related to the second mobile device 300. The second control unit 360 has a second encoder/decoder 361. Specifically, the second control unit 360 controls the second short distance communication unit 320 to receive the encoded DRM content from the first mobile device 200. Additionally, the second control unit 360 controls the second display unit 350 to display a key input interface for entering a key for decoding the encoded DRM content. When the second input unit 340 creates an input signal in response to a user's key input, the second control unit 360 receives the input signal from the second input unit 340 and recognizes the user's key input. The second encoder/decoder 361 determines whether the recognized key is identical to the encoding key of the received DRM content and, if identical, decodes the encoded DRM content by using the recognized key.

Furthermore, the second control unit 360 controls the second short distance communication unit 320 to receive the encoded DRM content from the first mobile device 200 and stores the encoded DRM content in the second memory unit 330. When the second input unit 340 creates an input signal in response to a user's instructions to play the encoded DRM content, the second control unit 360 receives an input signal from the second input unit 340 and controls the second display unit 350 to display the key input interface for entering a key for decoding the encoded DRM content. Thereafter, if a user enters a key that is identical to the encoding key, the second encoder/decoder 361 determines whether the entered key is identical to the encoding key, and then decodes the encoded DRM content by using the entered key. Finally, the second control unit 360 also controls the second audio processing unit 310 or the second display unit 350 to play the decoded DRM content.

In one embodiment, the second mobile device 200 may further include a second wired communication unit (not shown). The second wired communication unit may be formed of a specific connector that is coupled to the first mobile device 200 through a wired cable. The second control unit 360 may also receive the encoded DRM content from the first mobile device 200 through the second wired communication unit.

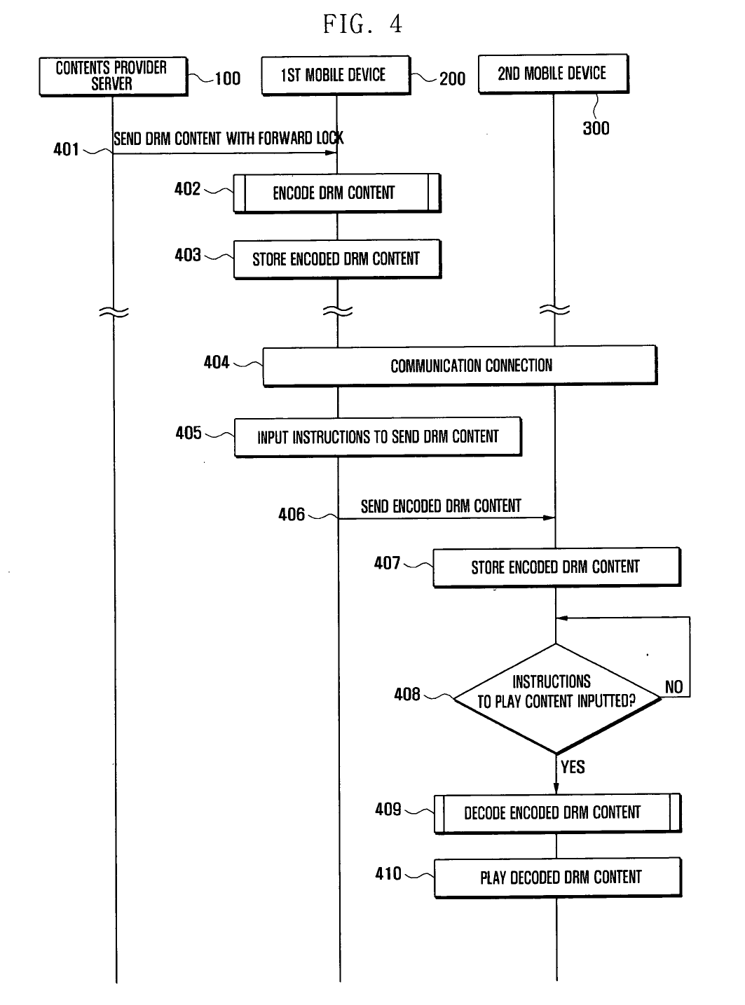

FIG. 4 illustrates a DRM content managing process in accordance with an embodiment of the present invention. This process is implemented among the content provider server 100, the first mobile device 200 and the second mobile device 300.

Referring to FIG. 4, at the outset, the content provider server 100 sends the DRM content with a forward lock 401 to the first mobile device 200. For instance, the first mobile device 200 forms a communication channel with the content provider server 100 through the mobile communication system 400 and then requests that the content provider server 100 sends the DRM content. At this time, the first mobile device 200 may allow a user to select a way to provide DRM content from among a forward lock, a combined delivery of content and right object, and a separate delivery of content and right object.

A combined delivery of content and right object is a way to offer the DRM content to which a right object such as usable count or usable time is added. In this situation, the mobile device plays the DRM content after obtaining certification of a right object from an authentication server. A separate delivery of content and right object is a way to separately offer content and a right object. Here, the DRM content is encoded and stored in the form of DCF (DRM content format) and decoded by means of CEK (content encryption key) contained in a right object. A forward lock is a way to offer the DRM content only without any license information such as a right object. Here, the DRM content has forward lock information created to prevent a copy or delivery to other external devices.

If a user selects a forward lock among the above three options, the content provider server 100 creates forward lock information in the DRM content and sends it to the first mobile device 200. In some embodiment, a way of offering DRM content may be fixed or defaulted on a forward lock. When the first mobile device 200 requests transmission of the DRM content, the content provider server 100 creates forward lock information in the requested DRM content and sends it to the first mobile device 200.

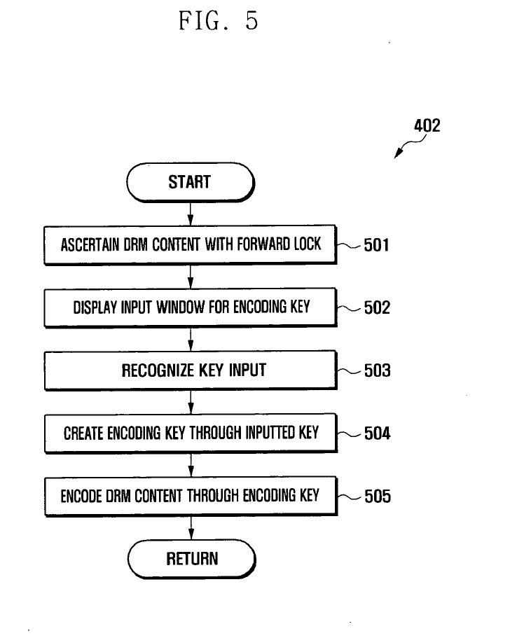

After receiving the DRM content from the content provider server 100, the first mobile device 200 encodes the received DRM content in block 402. This encoding is performed by using a specific key entered by a user. A detailed process regarding the encoding process in block 402 is shown in FIG. 5.

FIG. 5 illustrates a process for encoding DRM content by the first mobile device in accordance with an embodiment of the present invention.

Referring to FIG. 5, in block 501, the first control unit 270 ascertains that the DRM content received from the content provider server 100 has a forward lock created therein. In some embodiments, the first control unit 270 may include a DRM agent that manages DRM contents, and block 501 may be performed by such a DRM agent.

In block 502, the first control unit 270 controls the first display unit 260 to display an input interface for entering an encoding key. In block 503, the first control unit 270 controls the first input unit 250 to recognize a user's key input. Additionally, the first encoder/decoder 271 of the first control unit 270 designates a recognized key as an encoding key block 504 and encodes the DRM content received from the content provider server 100 by using the encoding key in block 505. Thereafter, the first mobile device 200 proceeds to block 403 in FIG. 4.

As discussed above, forward lock information created in the DRM content is to prevent a user from forwarding the DRM content to other devices. Actually, an act of forbiddance is conducted by the mobile device that receives the DRM content. When ascertaining that a forward lock is created in the DRM content, the mobile device performs a given process of encoding the DRM content such that the encoded DRM content may not be copied or sent to another device. In embodiments of this invention, the mobile device performs an encoding process such that the DRM content can be transmitted to other devices but not copied. Specifically, the first mobile device 200 designates a user's input key as an encoding key and then encodes the DRM content by using the encoding key. The encoded DRM content can be sent to other devices but not copied. Thereafter, when a key identical to the encoding key is entered in the other device, the DRM content can be decoded. In some embodiments of this invention, the first encoder/decoder 271 may use AES (advanced encryption standard) algorithm to encode the DRM content. This AES algorithm is to encode data by using a key of 128, 160, 192, 224 or 256 bits. The AES algorithm is, however, not to be considered as a limitation of this invention. Any other algorithms for encoding or decoding data through a specific key may be applied to this invention.

Returning to FIG. 4, the first mobile device 200 stores the encoded DRM content in block step 403. Specifically, the first control unit 270 stores the encoded DRM content in the first memory unit 240.

Next, the first mobile device 200 establishes a communication connection with the second mobile device 300 in block 404. According to embodiments of this invention, the first mobile device 200 may form a wired or wireless communication channel with the second mobile device 300. Specifically, a wired communication channel may be formed between the first and second wired communication units of the first and second mobile devices 200 and 300. Alternatively, a short distance communication channel may be formed between the first and second short distance communication units 230 and 320 of the first and second mobile devices 200 and 300. As discussed above, the first and second short distance communication units 230 and 320 may be formed of a Bluetooth module, a Zigbee module, a UWB module, an infrared communication module, and the like. For example, when a Bluetooth module is used, the first mobile device 200 broadcasts an inquiry signal through the first short distance communication unit 230. If a response signal to the inquiry is received from the second mobile device 300, the first mobile device 200 receives a pin code input from a user and then performs a connection (i.e., a pairing) with the second mobile device 300. Alternatively, the second mobile device 300 may instead perform the above process.

After a connection between the first and second mobile devices 200 and 300 is established, the first mobile device 200 receives instructions to send the encoded DRM content to the second mobile device 300 in block 405 and, therefore, transmits the encoded DRM content 406 to the second mobile device 300. In block 407, the second mobile device 300 receives the encoded DRM content and stores it therein. Specifically, the second control unit 360 controls the second wired communication unit or the second short distance communication unit 320 to receive the encoded DRM content and stores it in the second memory unit 330.

In block 408, the second mobile device 300 determines whether there is an input of instructions to play the encoded DRM content. Specifically, if a user selects the encoded DRM content stored in the second memory unit 330 and then inputs instructions to play the selected DRM content, the second input unit 340 creates an input signal and sends it to the second control unit 360. Therefore, the second control unit 360 recognizes that instructions to play the encoded DRM content are entered. The second mobile device 300 decodes the encoded DRM content to be played in block 409.

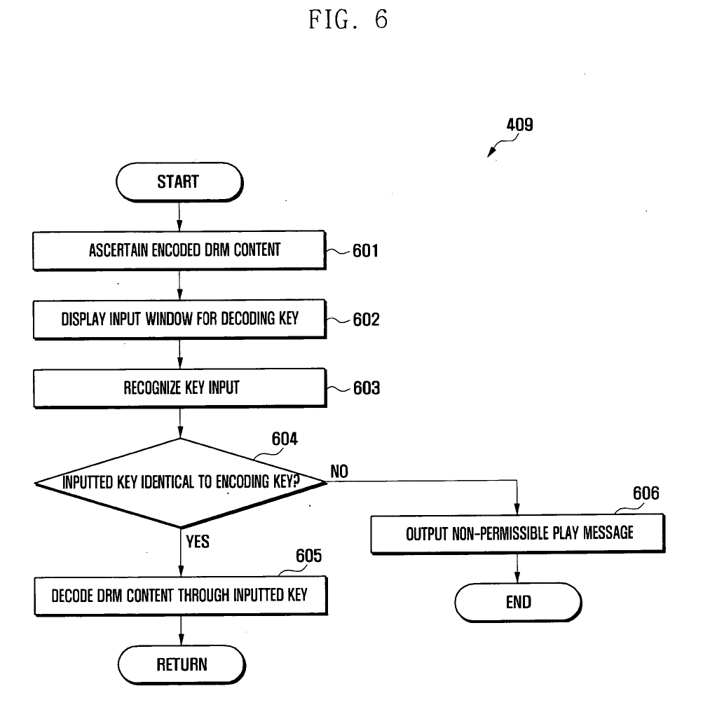

In some embodiments, on receipt of the encoded DRM content from the first mobile device 200, the second mobile device 300 may perform the above decoding block 409. The second mobile device 300 decodes the DRM content and stores it therein. If user's instructions to play the stored content are received, the second mobile device 300 immediately plays the DRM content without additional decoding. A detailed process regarding block 409 is shown in FIG. 6.

FIG. 6 illustrates a process for decoding DRM content by the second mobile device in accordance with an embodiment of the present invention.

Referring to FIG. 6, the second control unit 360 ascertains that the DRM content received from the first mobile device 200 is encoded in block 601. In some embodiments, the second control unit 360 may include a DRM agent that manages DRM contents, and block 601 may be performed by such a DRM agent.

In block 602, the second control unit 360 controls the second display unit 350 to display an input interface for a decoding key. In block 603, the second control unit 360 controls the second input unit 340 to recognize a user's key input. Additionally, the second encoder/decoder 361 of the second control unit 360 determines whether a recognized key is identical to the encoding key used for encoding the DRM content in block 604. The DRM content transmitted to the second mobile device 300 is encoded and hence needs key information for decoding. Therefore, the second mobile device 300 requires a user's key input by displaying an input interface for a decoding key and uses the entered key for decoding the DRM content. However, if the key entered by a user is not equal to the encoding key, the entered key cannot be used for decoding the DRM content.

In block 605, the second encoder/decoder 361 decodes the encoded DRM content by using the entered key. The second encoder/decoder 361 decodes the DRM content by executing an encoding/decoding application stored in the second memory unit 330. Here, the encoding/decoding application is the as analogous to that stored in the first memory unit 240 of the first memory device 200. In some embodiments, the second encoder/decoder 361 uses the same encoding/decoding algorithm as the first encoder/decoder 271. For instance, both the first encoder/decoder 271 and the second encoder/decoder 361 may use the aforesaid AES algorithm using a 128-bit key. Therefore, if a key identical to the encoding key is entered, the second mobile device 300 can decode the DRM content encoded by the first mobile device 200.

If the second encoder/decoder 361 determines in block 604 that the entered key is not identical to the encoding key, the second control unit 360 controls the second display unit 350 to display a message indicating that the DRM content is not permissible to play in block 606. When the second mobile device 300 proceeds to block 409 as soon as the encoded DRM content is received, the second control unit 360 may control in block 606 the second display unit 350 to display another message indicating that the DRM content is not permissible to store.

Upon successfully decoding the DRM content using the entered key, the second mobile device 300 plays the decoded DRM content in block 410. Specifically, the second control unit 360 controls the second audio processing unit 310 or the second display unit 350 to output audio data or graphic data.

In some embodiment of this invention, if a user wishes to send back the DRM content from the second mobile device 300 to the first mobile device 200, the second mobile device 300 performs blocks 402 to 405, and the first mobile device 200 performs blocks 407 to 409. If any third device uses the same encoding/decoding algorithm as the first and second mobile devices 200 and 300, and further, if the third device can establish a communication channel with the first or second mobile device 200 or 300, the third device can send and receive the DRM content to and from the first or second mobile device 200 or 300.

As fully discussed above, the present invention may allow a user to play the DRM content in a selected device among his devices. Additionally, the present invention may prevent unauthorized redistribution since the DRM content can be transmitted to another device but not copied.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for managing DRM (digital rights management) content, the method comprising:
receiving DRM content from a content provider server;
encoding the DRM content by using an encoding key based on a user input such that the encoded DRM content cannot be decoded by another device without the encoding key; and
transmitting the encoded DRM content to an another mobile device after establishing a communication channel with the another mobile device.

2. The method of claim 1, wherein encoding the DRM content by using the encoding key comprises:
determining whether the received DRM content includes a forward lock; and
encoding the DRM content by using the encoding key based on the user input in response to determining that the received DRM content includes the forward lock.

3. The method of claim 1, further comprising decoding the encoded DRM content after comparing a key inputted by a user with the encoding key, by the another mobile device.

4. The method of claim 2, wherein the encoding of the DRM content further comprises:
displaying a key input interface for creating the encoding key;
recognizing a key entered by a user;
designating the entered key as the encoding key; and
encoding the DRM content by using the encoding key.

5. The method of claim 3, wherein decoding the DRM content comprises:
displaying a key input interface for decoding the encoded DRM content;
recognizing a key entered by a user;
determining whether the inputted key is identical to the encoding key; and
if the inputted key is identical to the encoding key, decoding the DRM content by using the entered key.

6. The method of claim 1, wherein the DRM content is transmitted to the another second mobile device through a short distance communication unit, the short distance communication unit comprising at least one of a Bluetooth module, a Zigbee module, an ultra-wideband (UWB) module, an infrared communication module, a universal asynchronous receiver/transmitter communication (UART) module, and a universal serial bus (USB) communication module.

7. An apparatus for managing DRM (digital rights management) content, the apparatus comprising:
a short distance communication unit configured to receive an encoded DRM content from a transmitting device; and
a control unit configured to prompt a user to enter a key for decoding the encoded DRM content, determine whether the key entered by the user is identical to the encoding key of the received encoded DRM content, decode the DRM content when the key entered by the user is identical to the encoding key, and play the decoded DRM content.

8. The apparatus of claim 7, wherein the control unit prompts the user to enter the key for decoding the encoded DRM content in response to receiving instructions to play the DRM content.

9. The apparatus of claim 7, wherein the control unit outputs a message indicating that the DRM content is not permissible to play in response to determining that the key entered by the user is different from the encoding key.

10. The apparatus of claim 7, wherein the control unit, in response to receiving instructions to transmit the DRM content to a target device, prompts the user to enter an encoding key for encoding the encoded DRM content, encodes the DRM content using the encoding key, transmits the encoded DRM content to the target device.

11. An apparatus for managing DRM (digital rights management) content, the apparatus comprising:
a first communication unit configured to receive DRM content with a forward lock from a content provider server;
a display unit configured to display a key input interface for creating an encoding key for the DRM content;
an encoder configured to create the encoding key by using a first key entered into the key input interface, and to encode the DRM content by using the encoding key; and
a second communication unit configured to establish a communication channel with an external device, and to transmit the encoded DRM content to the external device.

12. The apparatus of claim 11, wherein the second communication unit is a short distance communication module.

13. The apparatus of claim 11, wherein the second communication unit is further configured to receive the encoded DRM content from the external device.

14. The apparatus of claim 13, wherein the display unit is further configured to display a key input interface for decoding the DRM content.

15. The apparatus of claim 14, further comprising:
a decoder configured to determine whether a second key entered into the key input window is identical to the encoding key and, if the entered key is identical to the encoding key, to decode the encoded DRM content by using the entered key.

16. The apparatus of claim 11, wherein the encoded DRM content cannot be decoded by another device without the encoding key.

17. The apparatus of claim 11, wherein the second communication unit transmits the encoded DRM content without copying the DRM content.

18. The apparatus of claim 14, wherein the short distance communication unit comprises at least one of a Bluetooth module, a Zigbee module, an ultra-wideband (UWB) module, an infrared communication module, a universal asynchronous receiver/transmitter communication (UART) module, and a universal serial bus (USB) communication module.

19. A system for managing DRM (digital right management) content, the system comprising:
a content provider server configured to transmit DRM content with a forward lock to a first mobile device;
the first mobile device configured to receive the DRM content with the forward lock from the content provider server, to create an encoding key by using a first user-entered key, to encode the DRM content by using the encoding key, to establish a communication channel with a second mobile device, and to transmit the encoded DRM content to the second mobile device; and
the second mobile device configured to establish the communication channel with the first mobile device, to receive the encoded DRM content from the first mobile device, to determine whether a second user-entered key is identical to the encoding key, and if the second user-entered key is identical to the encoding key, to decode the encoded DRM content by using the second user-entered inputted key.

20. The system of claim 1, wherein the first mobile device unit transmits the encoded DRM content to the second mobile device without copying the DRM content.
